(19) United States
(12) Patent Application Publication
(10) Pub. No.: US 2015/0267973 A1
(43) Pub. Date: Sep. 24, 2015

(54) TUBE HOLDING ELEMENT

(71) Applicant: TETRA LAVAL HOLDINGS & FINANCE S.A., Pully (CH)

(72) Inventors: Niklas Wisen, Hjarup (SE); Jaana Mathisson, Lund (SE)

(73) Assignee: Tetra Laval Holdings & Finance S.A., Pully (CH)

(21) Appl. No.: 14/435,917

(22) PCT Filed: Oct. 15, 2013
(86) PCT No.: PCT/EP2013/071544

§ 371 Date: Apr. 15, 2015

(30) Foreign Application Priority Data
Oct. 17, 2012 (SE) 1251183-8

(51) Int. Cl. F28F 9/18; B23K 31/02; F28F 9/26

(52) U.S. Cl. CPC F28F 9/18; F28F 9/26; B23K 31/02

(57) ABSTRACT

A tube holding element provided with at least one through hole and having a first side and a second side. The tube holding element is arranged to be attached to a tube via the second side. The through hole has a diameter D1 corresponding to an inner diameter of the tube.

### TECHNICAL FIELD

The invention generally relates to a tube holding element to be used, for instance, in a tubular heat exchanger for processing liquid food products.

### BACKGROUND OF THE INVENTION

Today, within the food processing business, it is well known to heat treat food products in order to make sure that pathogenic microorganisms are killed. It is today common practice to use heat exchangers for this purpose. There are different types of heat exchangers available, such as plate heat exchangers, tubular heat exchangers, scraped surface heat exchangers and coil heat exchangers. Generally, the different types of heat exchangers suit different products. For instance, the plate heat exchanger can be used for milk heat treatment, but not for treating products with fibers, such as orange juice. The tubular heat exchanger on the other hand can treat products with fibers and is therefore often chosen by customers requesting a flexible piece of equipment capable of treating products both with and without fibers.

When designing and manufacturing heat exchangers it is of uttermost importance to make sure that the equipment can be cleaned properly in order to make sure that food safety is not jeopardized. Further, like in all business, it is important to make sure that the cost for producing is kept low. This is for instance achieved by reducing the amount of material, reducing time for manufacturing and making sure that quality is kept at a high level. It is also important that the operation cost is kept at a low level. In the case for heat exchangers this means for instance that the heat transfer between the heat transfer medium and the product is at a high level since this implies reduced energy consumption.

For tubular heat exchangers, a particular area of interest is how inner tubes, in which product is fed, are fastened to a tube case. The tube case serves the dual purpose of positioning a set of inner tubes inside a shell, as well as providing a seal between the tube case and the shell, enabling product running in the inner tubes to be kept separated from a heat transfer medium or cooling medium running in the space between the inner pipes and the shell. For this purpose the tube case is arranged at one end of the set of inner tubes, and usually at both ends thereof. The fastening of the inner tubes, often made by welding, should be designed such that it can be manufactured efficiently with high quality. Further, the fastening should be made in such a way that the inner tubes can be arranged in an optimal way from a heat transfer perspective, in some situations meaning having the inner tubes placed close to each other.

Today, it is a common approach to weld the inner tubes to a front side of the tube case. That is, the inner tubes are fed through openings in the tube case and attached in an outer end of the tube case. By doing so the inner tubes and the tube case can easily be welded together before the inner tubes and the tube case is mounted in the tubular heat exchanger.

In the Japanese patent application with publication number JP2010117121 filed by Iwai Kikai Kogyo Co Ltd, it is suggested to have an additional welding made to a back side of the tube case for eliminating the risk that liquid remains in a gap between the inner tubes and the tube case and for reducing production costs since the tube case does not have to be processed.

A disadvantage of having weldings made to both the front side and the back side is that a closed space is formed between the two weldings. Having a closed space like this is a food safety risk. If the back side welding is broken microorganisms may get into the closed space. Since there is no easy way to inspect the back side welding this food safety risk is hard to detect, making the risk even more severe.

Thus, there is a need for further improved tubular heat exchangers with inner tubes attached to the tube case in a way that assures low production costs, high quality and food safety.

### SUMMARY

Accordingly, the present invention preferably seeks to mitigate, alleviate or eliminate one or more of the above-identified deficiencies in the art and disadvantages singly or in any combination and solves at least the above mentioned problems.

According to a first aspect it is provided a tube holding element provided with at least one through hole and having a first side and a second side, wherein said tube holding element is arranged to be attached to a tube via said second side, said through hole having a diameter D1, wherein said diameter D1 corresponds to an inner diameter of said tube.

An advantage is that no gap is formed between the tube holding element and the tube since the tube is placed next to the tube holding element and thereafter attached together, instead of feeding the tube through the tube holding element and thereafter attaching the tube in the front side of the tube holding element.

A positive effect of not having a gap is a reduced risk that food residues or other unwanted material is gathered.

A further positive effect of not having a gap is that no expansion of the tube is needed, which otherwise is needed in order to provide for a tight fitting between the tube holding element and the tube.

The through hole may comprise a main section having said diameter D1 and a length L1 and a receiving section being arranged for receiving said tube and having a diameter D2 and a length L2, wherein said second diameter D2 corresponds to an outer diameter of said tube.

An advantage of having the receiving section is that the tube may easily be kept in place during the welding process.

A further advantage of having the receiving section is that the interface area between the tube and the tube holding element is increased and that the welding can be placed closer to a mid section of the tube holding element. This provides for that that the risk of forming an unwanted waist on the tube when welding this to the tube holding element is reduced.

A first length L1 of said main section may be greater than a second length L2 of said receiving section.

An advantage of having the second length short is that this provides for that after having welded the tube holding element and the tube together the gap between these two can be closed such that no food residues or other unwanted products are gathered.

The second diameter D2 may be at least 8 mm or less than 200 mm.

A difference between said first diameter D1 and said second diameter D2 may be at least 0.5 mm or less than 5 mm.

The second length L2 may be at least 0.5 mm or less than 10 mm.

The first length L1 may be at least 15 mm or less than 100 mm.

The first length L1 and said second length L2 together may be greater than said second diameter D2.

Further, it may be provided a recess on said tube holding element, said recess facing said first side.

An advantage of having a recess is that weldings made on the back side of the tube holding element can more easily be inspected.

The first side may be planar.

An advantage of having a planar first side is that this provides for a more tight fitting with another module. In the case with front side weldings the front side is not planar due to the weldings.

The tube holding element may be a tube case.

According to a second aspect it is provided a tubular heat exchanger comprising a tube holding element according to the first aspect.

According to a third aspect it is provided a method for manufacturing a tubular heat exchanger, said method comprising placing at least one tube to a through hole of a tube holding element according to the first aspect via said second side of said tube holding element, placing a welding device in said through hole via said first side of said tube holding element, and welding said at least one inner tube to said tube holding element.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIGS. 1a and 1b illustrate an example of a tubular heat exchanger.

FIG. 2 illustrates an example of a cross sectional view of an interface between a tube case and inner tubes.

FIG. 3 illustrates another example of a cross sectional view of an interface between a tube case and an inner tube.

FIG. 4 illustrates still an example of a cross sectional view of an interface between a tube case and an inner tube.

FIG. 5 illustrates an example of a cross sectional view of a set of inner tubes and a tube case.

FIG. 6 illustrates another example of a cross sectional view of a set of inner tubes and a tube case.

FIG. 7 illustrates yet an example of a cross sectional view of a set of a tube case and an inner tube.

FIG. 8 illustrates yet another example of a cross sectional view of a set of a tube case and an inner tube.

### DETAILED DESCRIPTION OF PREFERRED EMBODIMENTS

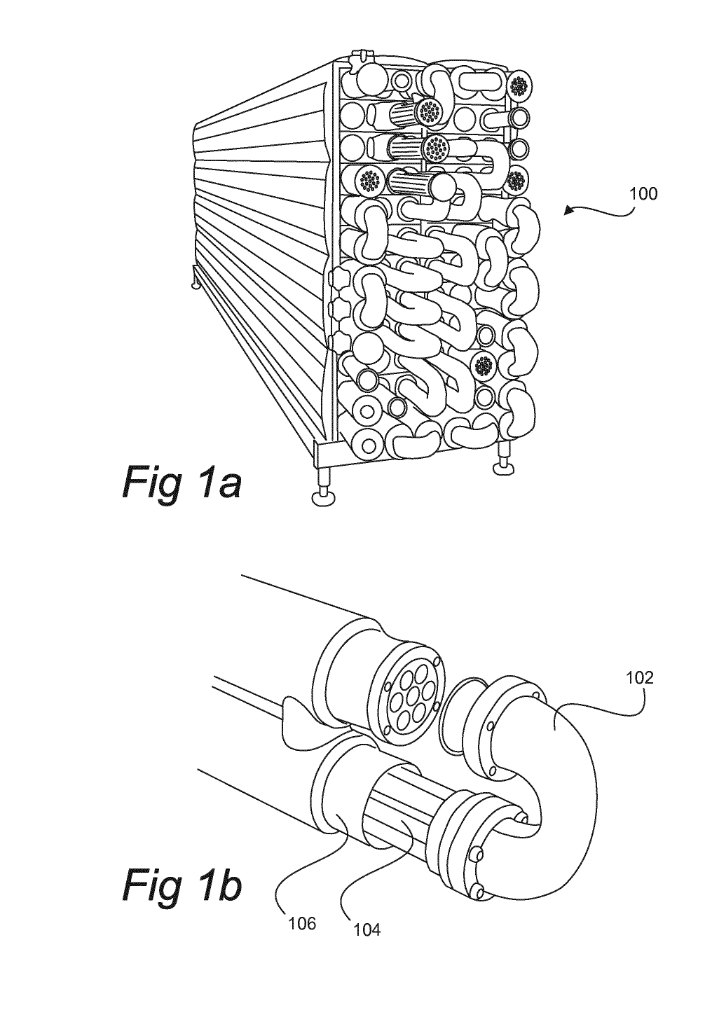

FIGS. 1a and 1b illustrates an example of a tubular heat exchanger 100, more particularly a Tetra Spiraflo™ marketed by Tetra Pak. As illustrated, a number of tubes are connected to each other via bend pipes 102 providing for a compact design. In the illustrated example, inner tubes 104 are kept in sets and each set is arranged in a bigger pipe referred to as a shell 106. The food product is fed through the inner tubes and a heat transfer medium is fed through the shell. In order to keep energy consumption low, it is advantageous to use outgoing food product, which is to be cooled down before being stored, as the heat transfer medium. Such system are often referred to as regenerative systems.

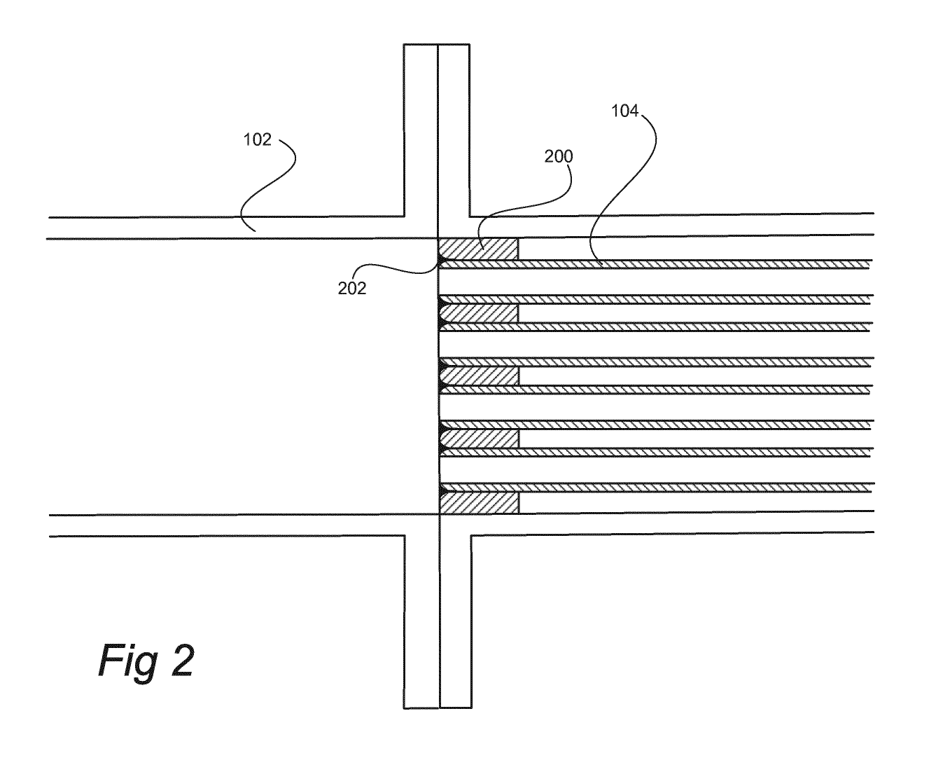

FIG. 2 illustrates an example of a cross sectional view of an interface between the bend pipe 102 and the inner tubes 104. Each set of inner tubes 104 can be attached to a tube case 200. The tube case 200 helps to keep the inner tubes 104 in place and provides for that the heat transfer medium on a shell side is hindered from coming into the bend pipe 102. Further, as illustrated in FIG. 1b, by having a set of inner tubes bundled together with the help of the tube case 200, it is possible to handle the set of inner tubes in a more convenient way. For instance, in case the tubular heat exchanger 100 needs to be rebuilt, the set of inner tubes 104 attached to the tube case 200 may be pulled out from the shell 106 and replaced by another inner tubes and tube case combination.

Today, the inner tubes are attached to the tube case by welding the inner tubes to a front side of the tube case, as illustrated in FIG. 2. An advantage of having front side weldings 202 is that they are easy to access, which makes manufacturing and inspection more convenient. Further, from heat transfer efficiency perspective, by having front side weldings the inner tubes 104 may be placed close to each other providing for that the welding of the inner tubes to the tube case does not hinder an optimal heat transfer design.

However, by having weldings in the front side of the tube case a gap may be formed between the inner tubes and the tube case on a back side of the tube case. If having a regenerative system, that is using a food product as the heat transfer medium, it is important to make sure that there is a tight fitting between the inner tubes and the tube case in order to avoid that food residues are caught in the gap.

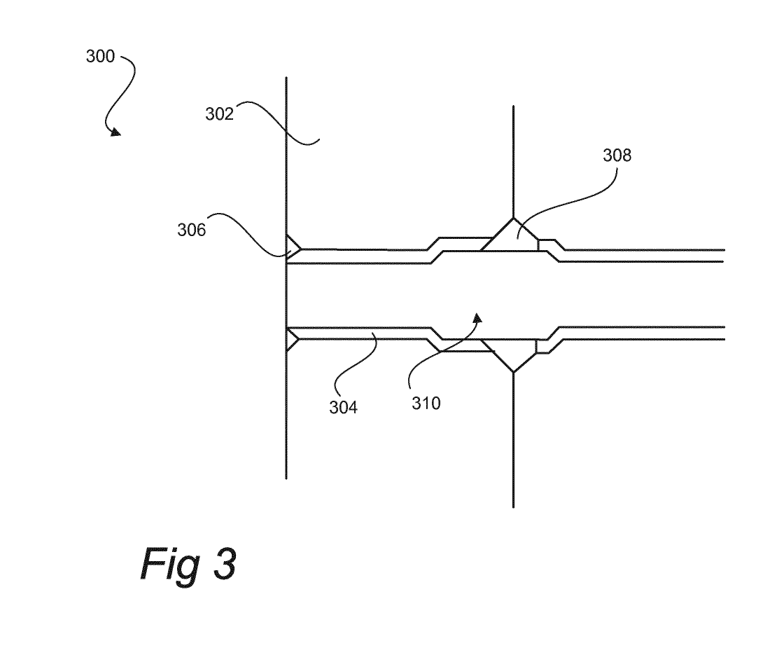

FIG. 3 illustrates part of a heat exchanger 300 having a tube case 302 attached to an inner tube 304 by both a front side welding 306 as well as a back side welding 308. In order to provide room for a welding device a pipe section 310 with increased cross sectional area is provided. This approach of having the front side welding 306 combined with the back side welding 308 has been suggested by Iwai Kikai Kogyo Co Ltd via the Japanese patent application with publication number JP2010117121.

If using this approach and if the back side welding is broken, there is a risk that microorganisms are caught in a closed space formed between the front side welding 306 and the back side welding 308. Since there is no inspection hole provided this is a food safety risk.

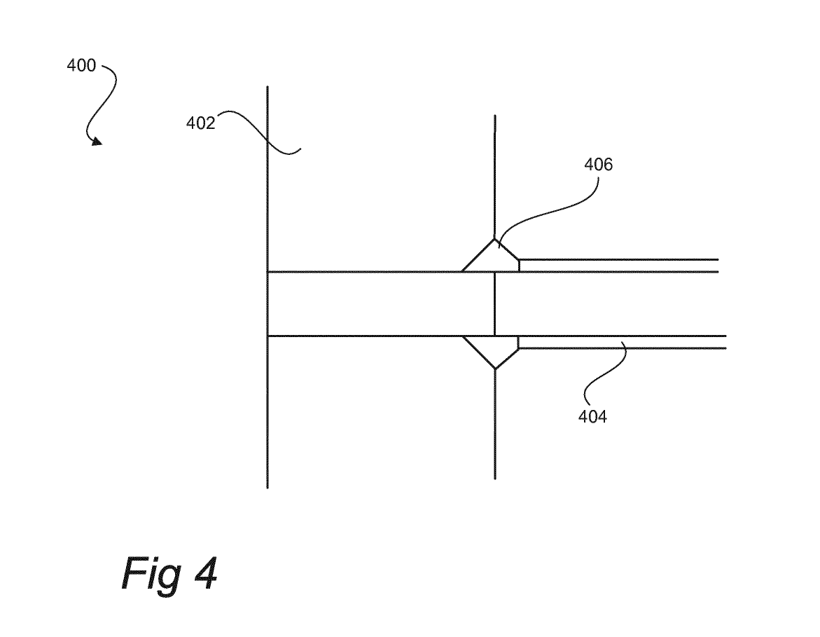

FIG. 4 illustrates part of a heat exchanger 400 having a tube case 402 attached to an inner tube 404 by a back side welding 406. By having only the back side welding 406 there is no closed space formed as in the heat exchanger 300 illustrated in FIG. 3. Further, since only one welding is used less time is needed for manufacturing.

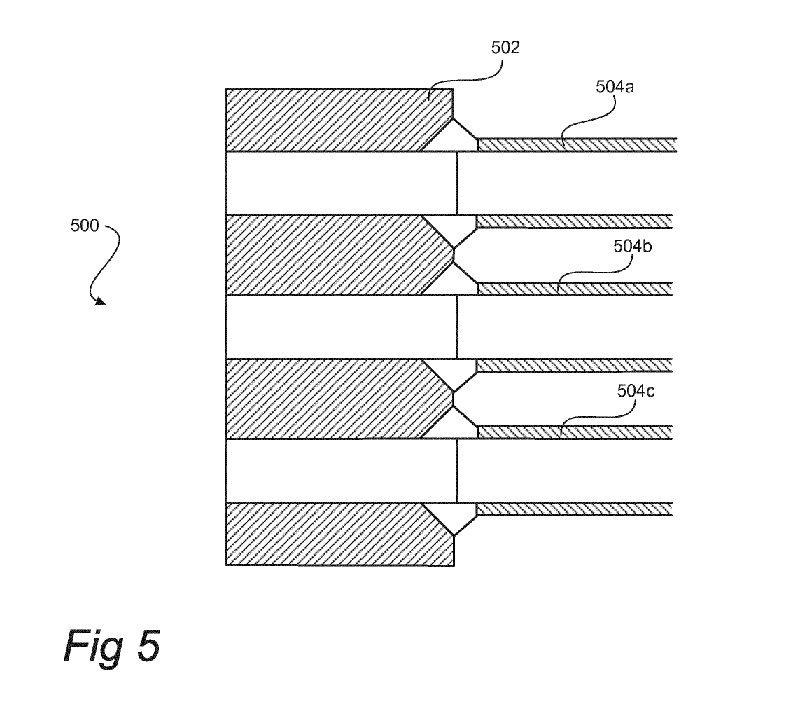

FIG. 5 illustrates an example of an end section 500 of a tube case and inner tubes combination comprising a tube case 502 and three inner tubes 504a, 504b, 504c. The inner tubes 504a, 504b, 504c are welded to the tube case 502 by back side weldings as illustrated in FIG. 5.

A further advantage of not having any front side weldings is that a very smooth planar surface may be provided on the front side providing for that it is easier to provide a tight fitting with a bend pipe or any other module attached to the tube case 502.

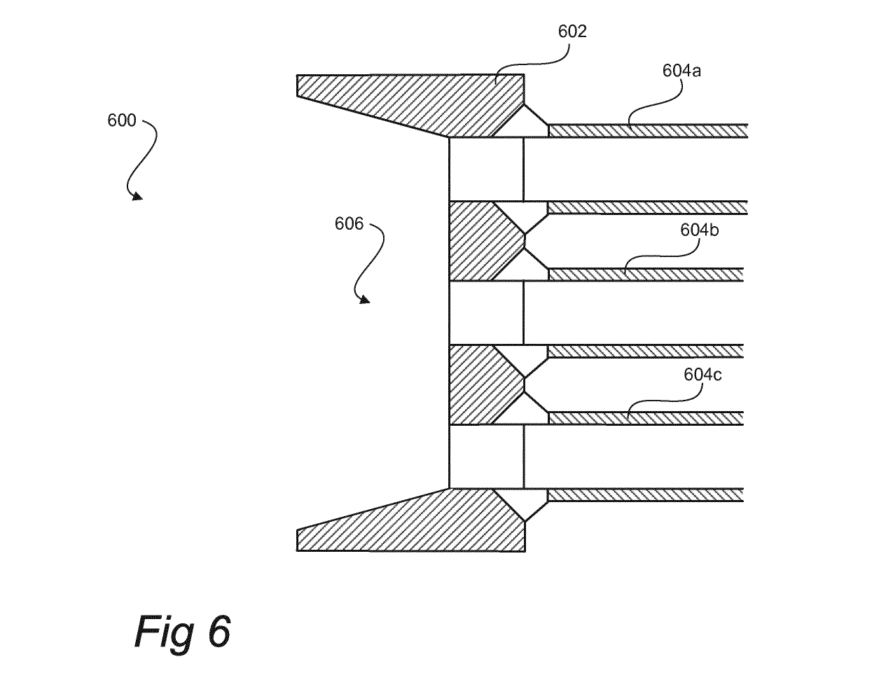

FIG. 6 illustrates another example of an end section 600 of a tube case and inner tubes combination comprising a tube case 602 and three inner tubes 604a, 604b, 604c. Unlike the example illustrated in FIG. 5, the tube case 602 is provided with a recess 606 providing for that the back side weldings can be easier to access and to inspect. The recess 606 may be applied to any embodiment and in a general aspect it corresponds that the tube case 602 has a reduced extension in the area of the backside weldings, as measured in an axial direction, i.e. in a length direction of the inner tubes or the corresponding openings in the tube case.

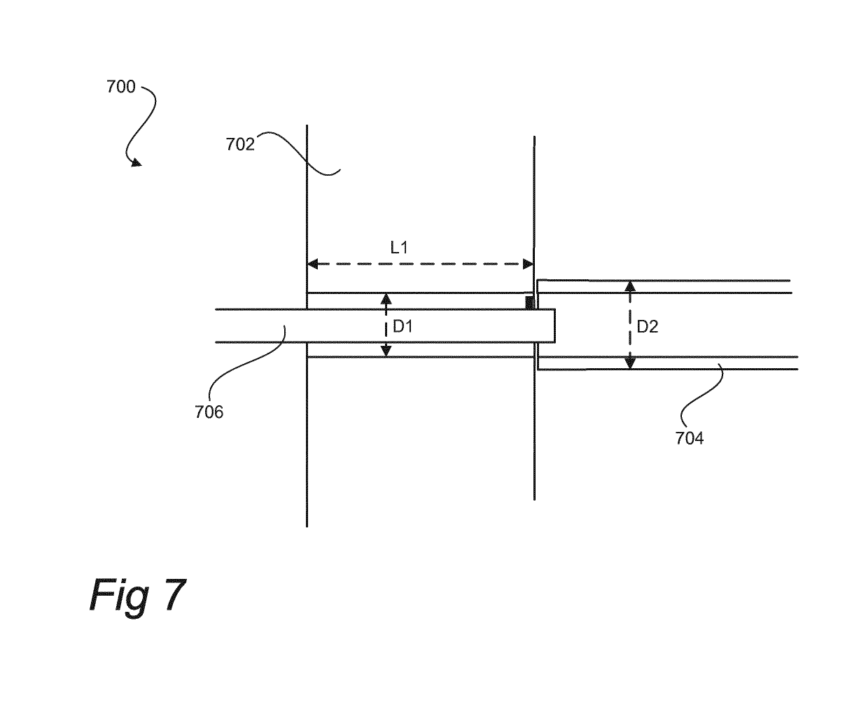

FIG. 7 illustrates an example of a tube case and inner tube arrangement 700 having a tube case 702 and an inner tube 704 being welded together using a welding device 706.

After having placed the inner tube 704 in line with the through hole on a back side, the welding device 706 can be inserted from a front side. In order to provide for a smooth transition between the through hole of the tube case and the inner tube the inner diameter D1 can correspond to the inner diameter of the inner tube.

An advantage of using this approach for attaching the inner tube 704 to the tube case 702 is that no expansion of the inner tube 704 is necessary. More specifically, since the inner tube 704 is not fed into the through hole there is no need to make sure that the inner tube is in tight fit with the tube case by using an expansion device for pressing out the inner tube towards the tube case. Therefore, apart from reducing the risk that microorganisms are caught in the gap between the tube case and the inner tube, the step of expansion before welding can be omitted.

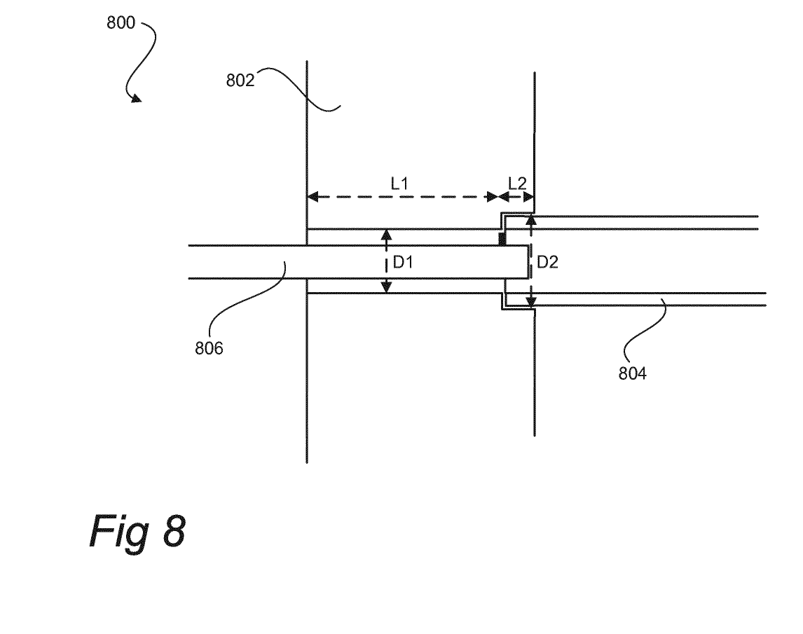

As illustrated in FIG. 8, in a tube case and tube arrangement 800, in order to achieve a tight fitting between the tube case 802 and the inner tube 804 and in order to provide for that no sharp edges are formed, such that efficient cleaning is facilitated, a diameter D1 of a main section of the through hole may correspond to an inner diameter of the inner tube 804, as illustrated in FIG. 7. Further, a receiving section may be provided in the back side of the tube case. The receiving section may have a diameter D2 that correspond to an outer diameter of the inner tube 804 in order to provide for a good fit.

Further, in order to make sure that no gaps are formed, a length L2 of the receiving section, arranged for receiving the inner tube 804, can be in the range of 1 to 4 mm. A reason for having the length L2 of the receiving section short is that it is in this way easier to make sure that there is no gap between the inner tube 804 and the tube case 802, after having welded the tube to the tube case.

A length L1 of the main section may be in the range 15 to 100 mm. The total length, that is the lengths L1 and L2 combined, is chosen dependent on the pressure to be held inside the tubular heat exchanger. In order to avoid accidents the total length is regulated in many cases by laws and industry guidelines.

An advantage of having the receiving section with the diameter D2 corresponding to the outer diameter of the inner tube and the main section with the diameter D1 corresponding to the inner diameter of the inner tube is that the inner tube can be received in said receiving section before attaching, e.g. by welding, the inner tube to the tube case. This implies that the inner tube can easily be held in place while attaching the inner tube. Further, if attaching by welding, having the inner tube received in the receiving section implies that the risk that a waist, i.e. a section with reduced thickness, is formed in the inner tube is reduced. One reason for this is that the receiving section provides for that the welding can be placed closer to a mid section of the through hole compared to when not having a receiving section, as illustrated in FIG. 7.

In order to provide efficient and high quality welding the welding device 706,806 may be controlled by an automatic welding system making sure that precise weldings are made.

The principles described above in relation to the tube case of a tubular heat exchanger can be used for any type of tube holding element arranged to be attached to a tube. Therefore, the tube case above should only be seen as an example of an application.

The material used for the pipes may be governed by regulations and standard, yet a typical example would be food grade stainless steel.

The invention has mainly been described above with reference to a few embodiments. However, as is readily appreciated by a person skilled in the art, other embodiments than the ones disclosed above are equally possible within the scope of the invention, as defined by the appended patent claims.

1. A tube holding element provided with at least one through hole and having a first side and a second side, wherein said tube holding element is arranged to be attached to a tube via said second side, said through hole having a diameter D1, wherein said diameter D1 corresponds to an inner diameter of said tube.

2. The tube holding element according to claim 1, wherein said through hole comprising a main section having said diameter D1 and a length L1 and a receiving section being arranged for receiving said tube and having a diameter D2 and a length L2, wherein said second diameter D2 corresponds to an outer diameter of said tube.

3. The tube holding element according to claim 2, wherein a first length L1 of said main section is greater than said second length L2 of said receiving section.

4. The tube holding element according to claim 2, wherein said second diameter D2 is at least 8 mm.

5. The tube holding element according to claim 2, wherein said second diameter D2 is less than 200 mm.

6. The tube holding element according to claim 2, wherein a difference between said first diameter D1 and said second diameter D2 is at least 0.5 mm.

7. The tube holding element according to claim 2, wherein a difference between said first diameter D1 and said second diameter D2 is less than 5 mm.

8. The tube holding element according to claim 2, wherein said second length L2 is at least 0.5 mm.

9. The tube holding element according to claim 2, wherein said second length L2 is less than 10 mm.

10. The tube holding element according to claim 1, wherein said first length L1 is at least 15 mm.

11. The tube holding element according to claim 1, wherein said first length L1 is less than 100 mm.

12. The tube holding element according to claim 2, wherein said first length L1 and said second length L2 together are greater than said second diameter D2.

13. The tube holding element according to claim 1, further comprising a recess facing said first side.

14. The tube holding element according to claim 1, wherein said first side is planar.

15. The tube holding element according to claim 1, wherein said tube holding element is a tube case.

16. A tubular heat exchanger comprising a tube holding element according to claim 1.

17. A method for manufacturing a tubular heat exchanger, said method comprising
placing at least one tube to a through hole of a tube holding element according to claim 1 via said second side of said tube holding element,
placing a welding device in said through hole via said first side of said tube holding element, and
welding said at least one inner tube to said tube holding element.
